(19) United States
(12) Patent Application Publication
(10) Pub. No.: US 2025/0142327 A1
(43) Pub. Date: May 1, 2025

(54) METHOD AND APPARATUS FOR AUTHENTICATING USERS IN WIRELESS COMMUNICATION SYSTEM

(71) Applicant: SAMSUNG ELECTRONICS CO., LTD., Suwon-si (KR)

(72) Inventors: Naman GUPTA, Suwon-si (KR); Jicheol LEE, Suwon-si (KR)

(21) Appl. No.: 18/927,708

(22) Filed: Oct. 25, 2024

(30) Foreign Application Priority Data
Oct. 25, 2023 (KR) 10-2023-0144150

(51) Int. Cl. H04W 12/06

(52) U.S. Cl. CPC H04W 12/06

(57) ABSTRACT

The disclosure relates to a 5G or 6G communication system for supporting a higher data transmission rate. According to an embodiment of the disclosure, a method performed by a user equipment (UE) comprises transmitting, to a UDM (unified data management), a first message for credentials for the UE, the credentials for the UE including at least one of name information, a mobile phone number, and a date of birth. The method comprises receiving, from the UDM, a second message indicating authentication success, wherein the second message includes a user ID corresponding to the credentials for the UE. The method comprises receiving, from an AMF (access and mobility management function), a third message to trigger local authentication of the UE. The method comprises performing the local authentication for the UE based on the second message and the third message.

### CROSS-REFERENCE TO RELATED APPLICATION

This application is based on and claims priority under 35 U.S.C. § 119 to Korean Patent Application No. 10-2023-0144150, which was filed in the Korean Intellectual Property Office on Oct. 25, 2023, the entire disclosure of which is incorporated herein by reference.

### BACKGROUND

### 1. Field

The disclosure relates to a procedure to authenticate a user, which may involve using a particular User-ID and providing that information to some external party.

### 2. Description of Related Art

5G mobile communication technologies define broad frequency bands such that high transmission rates and new services are possible, and may be implemented not only in “Sub 6GHz” bands such as 3.5GHz, but also in “Above 6GHz” bands referred to as mm Wave including 28GHz and 39GHz. In addition, it has been considered to implement 6G mobile communication technologies (referred to as Beyond 5G systems) in terahertz bands (for example, 95GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The contents in this disclosure describe how a network may perform a procedure to authenticate a user, which may involve using a particular User-ID and providing that information to some external party.

In prior art, any authentication related signaling between the User and the Authentications service provider are exchanged on an unsecure channel whereas in the procedure described in this disclosure, the message exchanges over the NAS which is a secure channel due to the already performed Primary authentication by the UE and the Network.

According to an embodiment of the disclosure, a method performed by a user equipment (UE) comprises transmitting, to a UDM (unified data management), a first message for credentials for the UE, the credentials for the UE including at least one of name information, a mobile phone number, and a date of birth. The method comprises receiving, from the UDM, a second message indicating authentication success, wherein the second message includes a user ID corresponding to the credentials for the UE. The method comprises receiving, from an AMF (access and mobility management function), a third message to trigger local authentication of the UE. The method comprises performing the local authentication for the UE based on the second message and the third message.

The disclosure provides an efficient procedure to authenticate a user, which may involve using a particular User-ID and providing that information to some external party.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a flow chart for an authentication service via an application layer according to an embodiment of the disclosure.

FIGS. 2A and 2B illustrate a flow chart for a User-ID function triggering an AMF to start authentication according to an embodiment of the disclosure.

FIGS. 3A and 3B illustrate a flow chart for a User-ID function requesting UDM for user authentication, and the UDM triggering the AMF to start user authentication according to an embodiment of the disclosure.

FIG. 4 illustrates a UE implementation according to an embodiment of the disclosure.

FIG. 5 illustrates a UE implementation according to another embodiment of the disclosure.

FIG. 6 illustrates a structure of a UE according to an embodiment of the disclosure.

FIG. 7 illustrates a structure of a network entity according to an embodiment of the disclosure.

### DETAILED DESCRIPTION

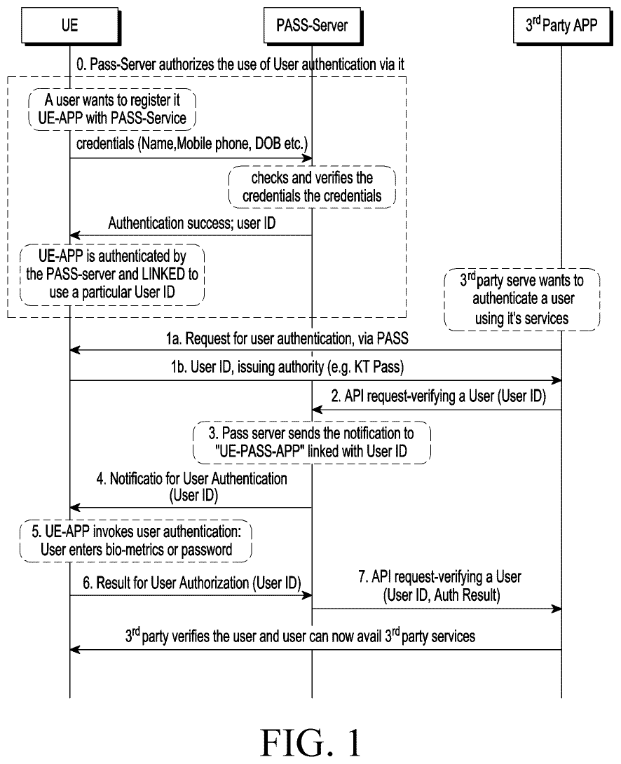

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, the operational principle of the disclosure is described below with reference to the accompanying drawings. When determined to make the subject matter of the disclosure unclear, the detailed of the known functions or configurations may be skipped. The terms as used herein are defined considering the functions in the disclosure and may be replaced with other terms according to the intention or practice of the user or operator. Therefore, the terms should be defined based on the overall disclosure.

For the same reasons, some elements may be exaggerated or schematically shown. The size of each element does not necessarily reflect the real size of the element. The same reference numeral is used to refer to the same element throughout the drawings.

Advantages and features of the disclosure, and methods for achieving the same may be understood through the embodiments to be described below taken in conjunction with the accompanying drawings. However, the disclosure is not limited to the embodiments disclosed herein, and various changes may be made thereto. The embodiments disclosed herein are provided only to inform one of ordinary skilled in the art of the category of the disclosure. The disclosure is defined only by the appended claims. The same reference numeral denotes the same element throughout the specification.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement execution examples, the functions mentioned in the blocks may occur in different orders. For example, two blocks that are consecutively shown may be performed substantially simultaneously or in a reverse order depending on corresponding functions.

As used herein, the term “ . . . unit” means a software element or a hardware element. The “ . . . unit” plays a certain role. However, the term “unit” is not limited as meaning a software or hardware element. A ‘unit’ may be configured in a storage medium that may be addressed or may be configured to reproduce one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. A function provided in an element or a ‘unit’ may be combined with additional elements or may be split into sub elements or sub-units. Further, an element or a ‘unit’ may be implemented to reproduce one or more CPUs in a device or a security multimedia card. According to embodiments, a “ . . . unit” may include one or more processors.

As used herein, each of such phrases as “A and/or B”, “A or B”, “at least one of A and B”, “at least one of A or B”, “A, B, or C”, “at least one of A, B, and C”, and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

In the disclosure, the user equipment (UE) may refer to a terminal, MS (mobile station), cellular phone, smartphone, computer, or various electronic devices capable of performing communication functions. According to the disclosure, the base station may be an entity allocating a resource to the UE and may be at least one of a gNode B, gNB, eNode B, eNB, Node B, BS, radio access network (RAN), base station controller, or node on network.

The embodiments of the disclosure may also apply to other communication systems with similar technical background or channel form. Further, embodiments of the disclosure may be modified in such a range as not to significantly depart from the scope of the disclosure under the determination by one of ordinary skill in the art and such modifications may be applicable to other communication systems.

In a specific description of the disclosure, a communication system may use various wired or wireless communication systems, e.g., the new RAN (NR), which is the radio access network, and the packet core (5G system, or 5G core network, or next generation core (NG core)), which is the core network, according to the 5G communication standard of the 3GPP which is a radio communication standardization organization. Embodiments of the disclosure may also be applicable to communication systems with a similar technical background with minor changes without significantly departing from the scope of the disclosure, and this may be possible under the determination of those skilled in the art to which the disclosure pertains.

As used herein, terms for identifying access nodes, terms denoting network entities (NEs), terms denoting messages, terms denoting interfaces between network functions (NFs), and terms denoting various pieces of identification information are provided as an example for ease of description. Thus, the disclosure is not limited by the terms, and such terms may be replaced with other terms denoting objects with equivalent technical concept.

An authentication service is a service that can allow users(or multiple UEs) to be able to log into applications and websites, without registering for or joining each service. The user (or UE) registers once with the Authentication service provider, and when that user (or UE) want to use some other application service, that application service can request the Authentication Service provider to authorize the already registered user (or UE).

User (or UE) thus has to authorize itself with the Authentication service provider only, and the application service is notified of the success or failure of the user authorization.

FIG. 1 illustrates a flow chart for an authentication service via an application layer according to an embodiment of the disclosure. FIG. 1 relates to a call flow involving a PASS server (or Authentication service provider).

Referring to FIG. 1, in step 0, PASS server (or Authentication service provider) authorizes the use of User authentication via itself. A User/UE first registers itself with an Authentication service. A User/UE first registers its UE-APP with PASS-Service.

User/UE may provide its credentials like Name, Mobile Phone Number, Date of Birth (DOB), etc. to the PASS server (or Authentication Service Provider). The PASS server (or Authentication service provider) checks and verifies the credentials. The PASS server (or Authentication service provider) transmits authentication success message including user ID corresponding to the UE.

PASS server (or Authentication service provider) then authorizes the use of a User ID and links the User ID to the particular UE (or to the particular UE-APP of the Authentication service provider installed in the UE).

Now if the UE/user tries to access a 3^{rd} party APP (or 3^{rd} party service), and the 3^{rd} party APP (or 3^{rd} party service) has relationship with the Authentication service provider, 3^{rd} party APP (or 3^{rd} party service) can prompt the UE/user to perform authentication with the PASS server (or Authentication Service provider).

In Step 1a, 3^{rd} party APP (or 3^{rd} party service) requests for user authentication via PASS server (or Authentication service provider) to the UE. In Step 1b, User/UE then provides its user identity and/or issuing authority to the 3^{rd} party APP (or 3^{rd} party service).

In Step 2, 3^{rd} party APP (or 3^{rd} party service) then asks the PASS server (or Authentication service provider) to verify if the particular UE/user identified by the User ID is an actual UE/user and registered with the PASS server (or Authentication service provider).

In Step 3, PASS server (or Authentication service provider) may need to prompt again for user authentication. In Step 4, the PASS server (or Authentication servicer provider) does so by sending a notification to the application registered with the User ID, to perform authentication for the user.

In Step 5, UE/User is prompted to provide bio-information, or password, etc. UE-APP (UE application) invokes user authentication (For example, user enters bio-metrics or password).

In Step 6, upon confirming the authentication, the application notifies the Authentication service provider regarding the result of the authentication. The UE transmits result for user authorization including user ID to PASS server (or Authentications service provider).

In Step 7, PASS server (or Authentications service provider) then provides this result to the 3^{rd} party APP (or 3^{rd} party service), which upon confirming the authenticity of the User, grants the particular User the access to the resource provided by the 3^{rd} party APP (or 3^{rd} party service). The PASS server (or Authentications service provider) transmits API request verifying a user (user ID and/or authentication result) to the 3^{rd} party APP. The 3^{rd} party APP (or 3^{rd} party service) verifies the UE/user and the UE/user can now avail 3^{rd} party service.

Authentication related to the 5GC (like slice authentication, or DNN authentication, or regular primary authentication) requires UE to send some associated credentials (which UE had already received earlier) to the network, where some entity (internal to network or 3^{rd} party) verifies those credentials, and thus authenticates the usage of particular resources.

Local authentication is based on the trusted hardware in the UE. Based on the mechanism to authenticate at the UE (e.g., using fingerprints, local password or PIN), network may configure and authorize the UE to associate a particular authentication mechanism with a particular resource. When a user of the UE wants to access that particular resource from the network, network may ask the UE to perform the local authentication and inform the network about the result of authentication (that is whether authentication was successful or not).

Thus during local authentication, UE authenticates the User against credentials stored local on the UE, and notifies the network about the success/failure of the authentication.

Local authentication like biometric authentication, passcode, etc. provide user an effortless/convenient way to access the devices, without having to provide credentials to the network again and again.

### User Authentication with User-ID function triggering Authentication

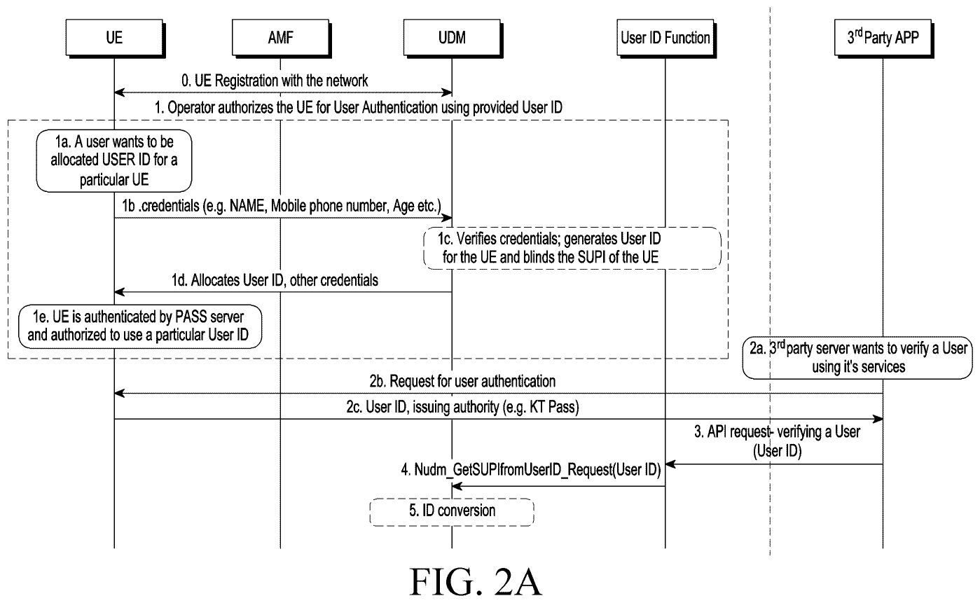

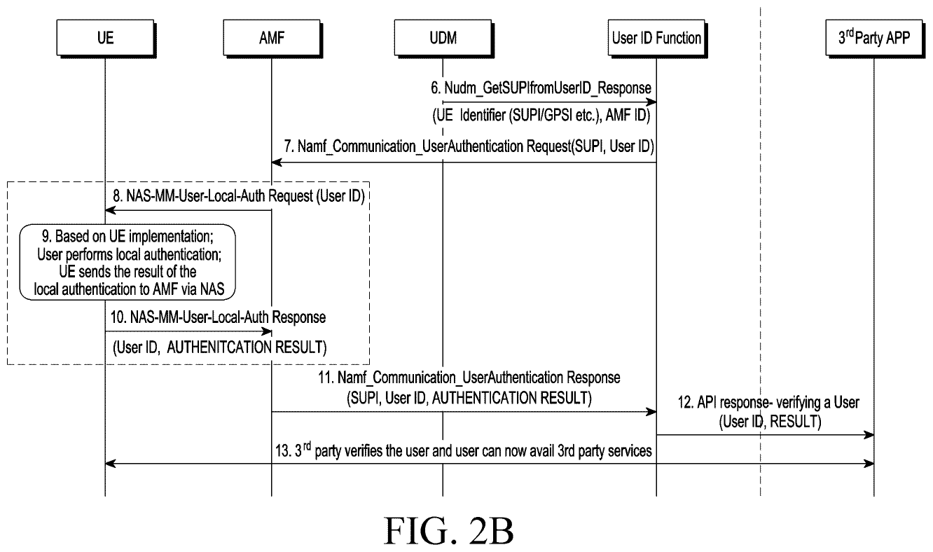

FIGS. 2A and 2B illustrate a flow chart for a User-ID function triggering an AMF to start authentication according to an embodiment of the disclosure.

Referring to FIGS. 2A and 2B, a system includes UE, AMF (Access and Mobility Management Function), UDM (Unified Data Management), USER-ID Function, and 3^{rd} party APP.

Procedure provides a 3^{rd} party or local operator's application server, the verification of authentication of a User Identity, based on that identity being provided in Step 2a to the 3^{rd} party, where that User is using a UE already being registered with the network and the User identity being associated with the SUPI (Subscription Permanent Identifier) of the UE in Step 1.

Step 0. UE registers with the network.

Step 1. Operator authorizes the UE for user authentication using provided user ID

Step 1a. Based on local configuration and implementation, a user using a UE, decides to configure this UE with a User identity.

Step 1b. UE asks the network for authorization and authentication to use a User ID. UE may provide some credentials to the network (or UDM). According to an embodiment, credentials includes at least one of user name, mobile phone number, or user's age.

Step 1c. Network (UDM and/or User-ID function) verifies the credentials provided by the UE, allocates a User-ID for the requesting UE. Network updates its configuration (configuration of the particular User-ID Profile, association of the User Identity and the SUPI, etc.).

Step 1d. Network (some network entity e.g., UDM and/or User-ID function, etc.) sends UE the information regarding authentication and authorizing of User Identifiers (e.g., credentials associated with User Identifiers, User Identifier, authentication method, etc.).

Step 2.

Step 2a. 3^{rd} party server (or 3^{rd} party APP) wants to authenticate a user which is using its services.

Step 2b. On application layer or otherwise, User may be sent a message to provide information so that 3^{rd} party may use service of an Authentication service provider for verifying the authenticity of this particular User. The 3^{rd} party server (or 3^{rd} party APP) sends request for user authentication to the UE.

Step 2c. UE provides 3^{rd} party application with its User ID and optionally an External UE identifier (e.g., MSIDN, AKMA-ID), name of the identity provider (e.g., name of the operator or the name of the authority which issued the User identity).

Step 3. Application server (which may be an AF run by a 3^{rd} party) sends API request verifying a user (user ID) to User-ID function.

The application server (which may be an AF run by a 3^{rd} party) sends API request verifying a user (user ID) to User-ID function, after receiving the details from the user in Step 2c.

Step 4. User-ID function sends Nudm_GetSUPIfromUserID_Request including user ID to UDM.

The user-ID function asks whether and which UE is linked or associated with a particular User-ID.

The user-ID function may also request for receiving the serving AMF of the particular UE which is linked with the User-ID.

Step 5. UDM operation: ID conversion.

Based on the procedure in Step 1, the entity (UDM here) checks the linked UEs (or the linked UE identifiers) to the User ID.

Step 6. UDM sends Nudm_GetSUPIfromUserID_Response to User ID function.

The UDM provides the associated UE ID (SUPI/GPSI (Generic Public Subscription Identifier)) and the AMF(s) of the UE to the user ID function.

Step 7. User ID function sends Namf_Communication_UserAuthentication Request to AMF.

The user ID function sends AMF the message to perform user authentication by providing UE identifier (SUPI/GPSI) and/or User Identifier.

Alternatively, instead of AMF, the user ID function may also send this message to entity like AUSF (Authentication Server Function)/NSSAAF (Network Slice-specific Authentication and Authorization Function), and accordingly will receive the response from the same entity in Step 11.

Alternatively, instead of User ID function, AMF may receive this message from some other 5G entity like UDM, AUSF NEF, etc.

Step 8. AMF sends request (NAS-MM-User-Local-Auth Request) for performing User Local Authentication/User Authentication to UE.

AMF sends the UE (via NAS) the message to trigger User Local Authentication/User Authentication for the particular User ID received in Step 7.

Step 9. Based on the request received from the network (or the AMF), UE triggers authentication procedure for User Identity received from network in Step 8. The UE utilizes the stored configuration and information negotiated with the network in Step 1 (1a, 1b, 1c, 1d). The UE trigger the Authentication procedure for the particular User ID provided by the Network.

Based on the UE configuration for the User ID, UE may trigger an authentication procedure (e.g., EAP authentication) by providing credentials to the network,

According to an embodiment, the UE may perform a local authentication for the particular User ID and provide network with the result of local authentication in Step 10.

Step 10. UE provides the response (NAS-MM-User-Local-Auth Response) for User ID authentication to the network (AMF).

Step 11. AMF sends Namf_Communication_UserAuthentication Response to the USER-ID function. The Namf_Communication_UserAuthentication Response includes at least one of SUPI, User ID, or authentication result.

The AMF sends the User ID function the message corresponding to User ID authentication performed by UE and received in Step 10.

Step 12. User ID Function sends API response verifying a user (user ID, Result for the authentication) to Application server.

The user ID function receives the response in Step 11 and send the application server the result for the authentication for the User ID.

The methods described for below entities may be partly or wholly be performed by same or different network entities.

Referring to FIGS. 2A and 2B, operation by the AMF is described below.

According to an embodiment, Functionality described for AMF as below may also be realized by some other NF entity e.g., NEF, NSSAAF, etc.

AMF in Step 7 may receive from User-ID function, the message Namf_Communication_UserAuthentication (new message type) Request, which includes one or more parameters of User ID, SUPI, GPSI authentication-method.

Alternatively, AMF in Step 7, may receive a message with one or more parameters of “indication for performing User Authentication” User ID, SUPI, GPSI authentication-method.

Alternatively, AMF in Step 7, may receive a message with one or more parameters of User ID, SUPI, GPSI authentication-method.

Authentication-method may include type of method requested by the network, such as EAP method type, Local-Authentication (this can include information about the authority which

Upon receiving message in Step 7, AMF tries to reach and find the UE associated with SUPI and/or User ID, and if UE is not reachable, AMF will directly proceed to Step 11 and notify that UE can't be reached and/or authentication was unsuccessful, else

AMF in Step 8, transmits towards UE the message, NAS-MM-User-Local-Auth Request (new message type), including one or more parameters of User ID, authentication-method, in order to trigger UE to start performing authentication for the provided User ID, authentication-method.

Alternatively, AMF in Step 8, may transmit a message with “indication for performing User authentication” and one or more parameters of User ID, authentication-method.

Alternatively, AMF in Step 8, may transmit a message with one or more parameters of User ID, authentication-method.

AMF in Step 10, may receive from UE (directly or via another NF), as the response of the Step 8, the message NAS-MM-User-Local-Auth Response, which one or more parameters of User ID, User Authentication Related-Message.

Alternatively, AMF in Step 10, may receive a message having parameter “User authentication indication”, along with User ID, and User Authentication Related-Message.

Alternatively, AMF in Step 10, may receive the message including one or more parameters of User ID, User Authentication Related-Message.

In case Local authentication is performed by UE, the Authentication Related Message may contain Success/Failure indication and optionally the security certificate or credential related information of the party, which authorized the UE for local authentication for the User ID, or of the party responsible for performing local authentication for the User ID in the UE.

In case normal EAP authentication is performed, Authentication Related Message may also contain relevant EAP message according to the EAP method used.

Upon receiving message in Step 10 from UE, and/or as a response for the message received from User-ID function in Step 7, AMF determines if the User-ID is authenticated or not and

AMF in Step 11, sends User-ID Function the message Namf_Communication_UserAuthentication Response including one or more parameters of SUPI, GPSI, User ID, Authentication Related-Message, indication whether UE is reachable or not.

Alternatively, AMF in Step 11, sends a message that include “indication of User Authentication result”, and one or more parameters of SUPI, GPSI, User ID, Authentication Related-Message, indication whether UE is reachable or not.

Alternatively, AMF in Step 11, sends a message that include one or more parameters of SUPI, GPSI, User ID, Authentication Related-Message, indication whether UE is reachable or not.

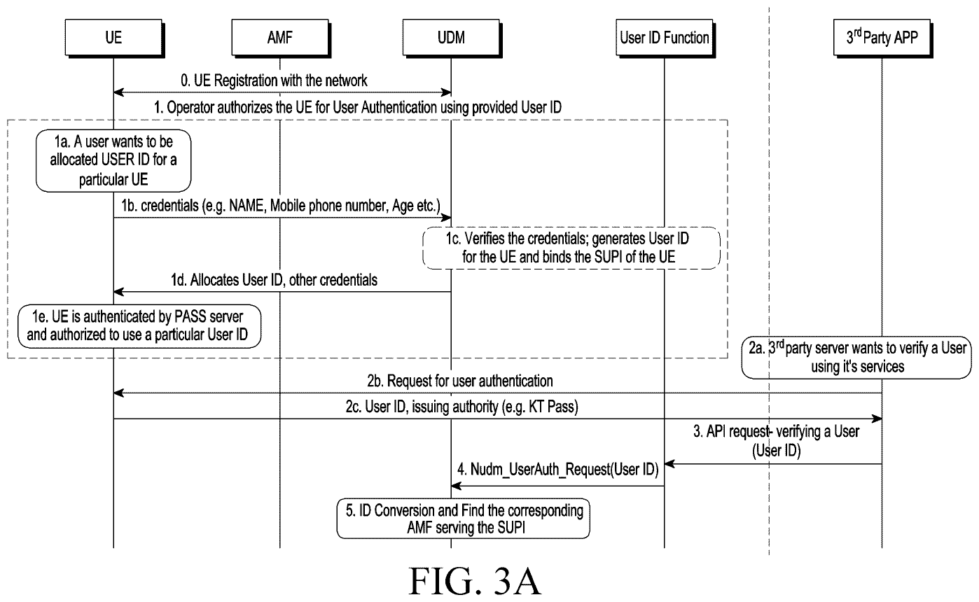

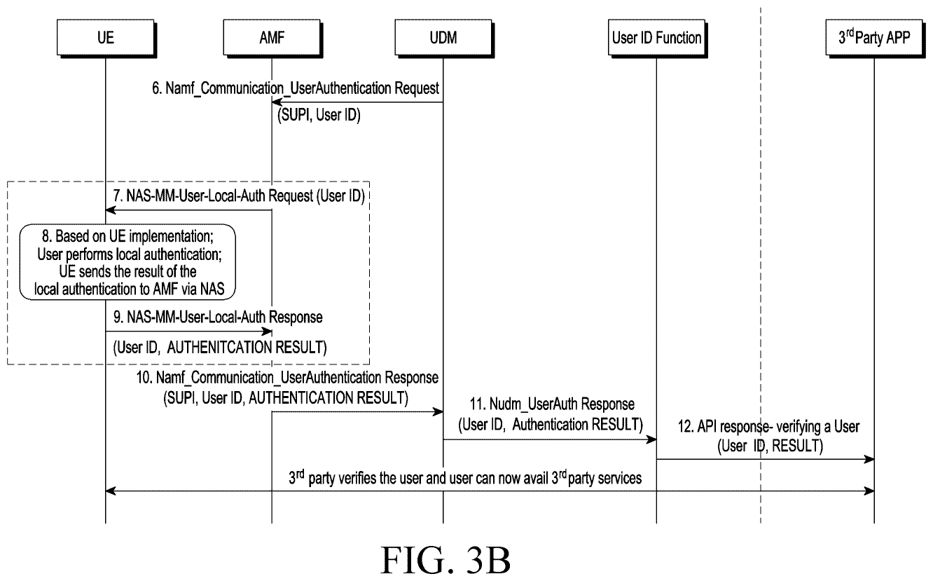

Referring to FIG. 2A to FIG. 3B, operation by the UE is described below. UE in Step 1.

1. The UE provides credentials to the Network and asks the network to register the UE with an User-ID.

2. Based on the Registration that UE performs for a SUPI, network can associate the SUPI of the UE, Network can store and associate the User ID with the SUPI.

3. The UE receives from the network configuration information, which may include the User Identifier, authentication method, credentials associated with User ID, etc.

UE which is identified by a subscription identifier (SUPI), provides information to Network in Step 1 and receives authorization from the network regarding usage of a particular User ID which is bind to its SUPI. UE may additionally receive information regarding how to authenticate for particular User ID (e.g., method of authentication (e.g., Bio-info, credentials associated with the User ID, certificate of issuing authority)

User using the particular UE in step 2a, 2b can negotiate with a 3^{rd} party regarding its User ID information and provide it with information related to issuer of the user identity (in this case the operator to which UE is registered to). Using this info, third party can request the issuer of the user identity to verify and authenticate the user, which is associated with the User ID.

Because the network has associated the particular User ID with the UE (in Step 1), and the UE is registered with the network, network finds the particular UE (that is associated with the User ID) and sends UE a message in Step 8 as described next.

UE in Step 8, can receive from the Network (via AMF) a NAS-MM-User-Local-Auth Request, which include one or more of the parameters of User ID, authentication-method.

Alternatively, AMF in Step 8, may transmit a message with “indication for performing User authentication” and one or more parameters of User ID, authentication-method.

Alternatively, AMF in Step 8, may transmit a message with one or more parameters of User ID, authentication-method.

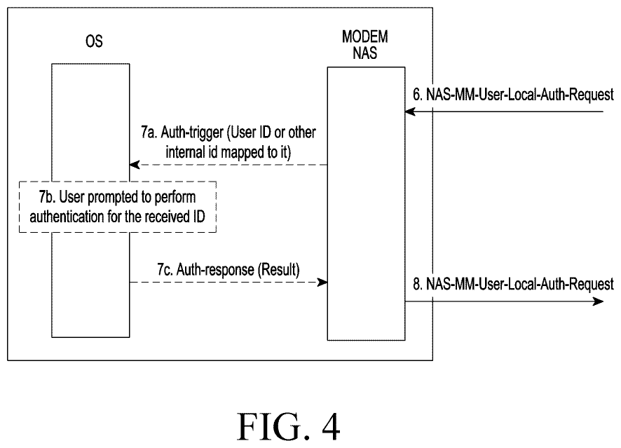

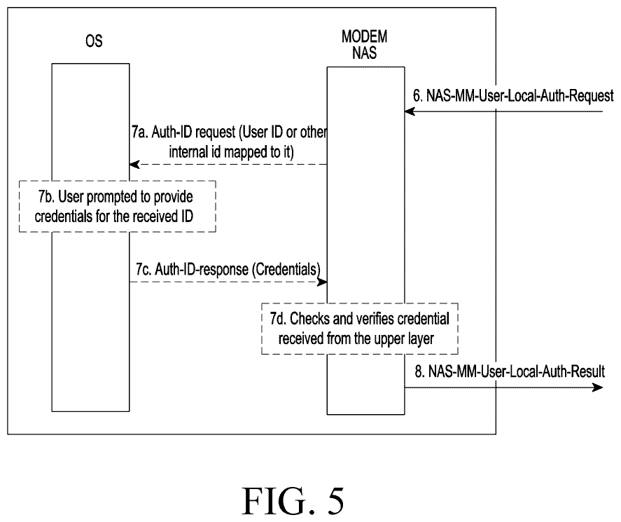

Step 9 is described in detail in FIG. 4 and FIG. 5.

Based on authorization performed by UE in Step 9, using the configuration information provided to UE in Step 1,

UE in Step 10, can send towards Network, as a response to Step 8, the message NAS-MM-User-Local-Auth Response, with one or more parameters of User ID, Authentication Related-Message. Alternatively, UE in Step 10, can receive a message having parameter “User authentication indication”, along with User ID, and User Authentication Related-Message.

Alternatively, UE in Step 10, can receive the message including one or more parameters of User ID, Authentication Related-Message.

Authentication Related-Message may contain a result (Success/Failure) of the Authentication, or an indication whether the user is active or not on the UE. It may further include the information regarding the authority which provided/stored credentials in the UE for User-ID authentication (e.g., digital certificate).

Alternative to performing Local Authentication as described in Step 9 and providing network with the result of local authentication in Step 10, network may request the UE to perform EAP authentication via the network and provide credentials associated with the User ID to the network. The Authentication Related-Message in Step 10 between the UE and the Network would then include EAP messages.

Referring to FIGS. 2A and 2B, operation by the USER-ID Function is described below.

According to an embodiment, some or all of USER-ID Function's functionality maybe realized via NEF or AF or NSSAAF or AUSF, and User ID functionality may be realized independently or together via GPSI or some Internal or External UE/User identifier or AKMA-ID.

User-ID Function in Step 3, may receive from a 5GS or a 3^{rd} party entity, a message to request authentication for a particular identifier (User ID/GPSI/External User ID), which includes one or more parameters of User ID.

Alternatively, User-ID Function in Step 3, may receive a message with “indication for performing User Authentication” and one or more parameters of User ID.

Upon receiving the message in Step 3 or based on some local configuration/triggers, User-ID function triggers the 5GS procedure, as depicted in Step 4 to Step 11, for performing User Authentication associated with a User Identifier that it received in Step 3, and

User-ID function in Step 4, transmits towards UDM (or some other control network entity like UDR) the message Nudm_GetSUPIfromUserID_Request, which includes one or more parameters of User-ID, AF identifier.

Alternatively, User-ID function in Step 4, may transmit a message, with “indication to perform ID conversion”, and one or more parameters of User ID, AF identifier.

Alternatively, User-ID function in Step 4, may transmit a message, with one or more parameters of User ID, AF identifier.

User-ID function in Step 6, as a response to Step 4, receives from UDM (or some other control network entity like UDR), the message Nudm_GetSUPIfromUserID_Request which includes one or more parameters of SUPI(s), GPSI(s), User-ID(s), AMF ID(s).

Alternatively, User-ID function in Step 6, may receive a message with “indication of ID conversion”, and one or more parameters of SUPI(s), GPSI(s), User-ID(s), AMF ID(s).

Alternatively, User-ID function in Step 6, may receive a message with one or more parameters of SUPI(s), GPSI(s), User-ID(s), AMF ID(s).

In the Step 4 and Step 6, the functionality described for UDM may also be realized by some other 5GS entity (e.g., BSF).

Upon receiving the message in Step 6 and/or upon receiving the message in Step 3, User-ID function triggers the procedure to authenticate the User which is associated to the identifier received in Step 3 or in Step 6, and,

User-ID function in Step 7, transmits towards AMF (or some other control network entity) the message Namf_Communication_UserAuthentication (new message type) Request, which includes one or more parameters of User ID, SUPI, GPSI authentication-method.

Alternatively, User-ID function in Step 7, may send a message with one or more parameters of “indication for performing User Authentication” User ID, SUPI, GPSI authentication-method.

Alternatively, User-ID function in Step 7, may send a message with one or more parameters of User ID, SUPI, GPSI authentication-method.

User-ID function in Step 11, as a response to Step 7, may receive from AMF (or some other control network entity), the message Namf_Communication_UserAuthentication (new message type) Response, including one or more parameters of SUPI, User ID, User Authentication Related-Message.

Alternatively, User-ID function in Step 11, may receive the message, including “indication of User Authentication result” and one or more parameters of SUPI, User ID, User Authentication Related-Message.

Alternatively, User-ID function in Step 11, may receive the message, including one or more parameters of SUPI, User ID, User Authentication Related-Message.

Upon receiving the message in Step 11, User-ID function checks and verifies whether the User-ID is authenticated or not by performing checks based on received User Authentication Related-Message (which may include digital certificate of issuing authority) and stored information and/or as a response to the message received in Step 3,

User-ID function in Step 12, transmits towards a 5GS or a 3^{rd} party entity, a message which includes one or more parameters of User ID, User Authentication Result-Message.

Alternatively, User-ID Function in Step 3, may receive a message with “indication of User Authentication result” and one or more parameters of User ID, User Authentication Result-Message.

User Authentication Result-Message may contain a result (Success/Failure) of the Authentication, or an indication whether the user is active or not on the UE.

Referring to FIGS. 2A and 2B, operation by the UDM is described below.

According to an embodiment, some or all of UDM's functionality maybe realized via some other Core Network Entity such as UDR.

It is assumed that the UDM (or the UDR) is configured with the association between a UE identity (such as SUPI) and between the User-Identity.

This configuration may be performed during Step 1 or otherwise by some other method.

UDM in Step 4, receives from User-ID Function (or some Control Network entity), the message Nudm_GetSUPIfromUserID_Request, which includes one or more parameters of User-ID, AF identifier.

Alternatively, UDM in Step 4, may receive a message, with “indication to perform ID conversion”, and one or more parameters of User ID, AF identifier.

Alternatively, UDM in Step 4, may receive a message, with one or more parameters of User ID, AF identifier.

UDM in Step 5, based on the message received in Step 4, finds the associated UE with the User ID.

And based on the stored or configured information performs the following:
Check the UEs (that are associated with the User ID) which are active,
Decides whether the authentication is needed for the UE or not, based on if that User ID was recently authenticated by the Network for this UE. A timer maybe stored in the UDM for this purpose,
Checks if the UE subscription allows it to use User IDs,
Checks the registered PLMN for the UE and checks if UE is allowed to user the User-ID or User-ID functionality in the particular PLMN (e.g., allowed to use in roaming) based on the Subscription data.

Based on the UDM operation in Step 5, if UDM determines that no UE is permitted or available for the particular User-ID, UDM in Step 6, may notify the User-ID function that no UEs are available, else
UDM in Step 6, based on the operation performed by UDM in Step 5, and/or as a response to Step 4, transmit towards User-ID Function, the message Nudm_GetSUPIfromUserID_Response that includes one or more parameters of SUPI(s), GPSI(s), User-ID(s), AMF ID(s).

Alternatively, UDM in Step 6, may send a message with “indication of ID conversion”, and one or more parameters of SUPI(s), GPSI(s), User-ID(s), AMF ID(s).

Alternatively, UDM in Step 6, may send a message with one or more parameters of SUPI(s), GPSI(s), User-ID(s), AMF ID(s).

FIGS. 3A and 3B illustrate a flow chart for a User-ID function requesting UDM for user authentication, and the UDM triggering the AMF to start user authentication according to an embodiment of the disclosure.

Referring to FIGS. 3A and 3B, a system includes UE, AMF (Access and Mobility management Function), UDM (Unified Data Management), USER-ID Function, and 3^{rd} party APP.

User-Authentication via NAS with UDM triggering Authentication.

Overall Procedure.

Step 0. UE registers with the network.

Step 1. Operator authorizes the UE for user authentication using provided user ID.

Step 1a. Based on local configuration and implementation, a user using a UE, decides to configure this UE with a User identity.

Step 1b. UE asks the network for authorization and authentication to use a User ID. UE may provide some credentials to the network. UE may provide some credentials to the network (or UDM). According to an embodiment, credentials includes at least one of user name, mobile phone number, or user's age.

Step 1c. Network (UDM and/or User-ID function) verifies the credentials provided by the UE, allocates a User-ID for the requesting UE. Network updates its configuration (configuration of the particular User-ID Profile, association of the User Identity and the SUPI, etc.).

Step 1d. Network (some network entity e.g., UDM and/or User-ID function, etc.) sends UE the information regarding authentication and authorizing of User Identifiers (e.g., credentials associated with User Identifiers, User Identifier, authentication method, etc.).

Step 2.

Step 2a. 3rd party server (or 3^{rd} party APP) wants to authenticate a user which is using its services.

Step 2b. On application layer or otherwise, User may be sent a message to provide information so that 3^{rd} party may use service of an Authentication service provider for verifying the authenticity of this particular User. The 3^{rd} party server (or 3^{rd} party APP) sends request for user authentication to the UE.

Step 2c. UE provides 3rd party application with its User ID and optionally an External UE identifier (e.g., MSIDN, AKMA-ID), name of the identity provider (e.g., name of the operator or the name of the authority which issued the User identity).

Step 3. Application server (which may be an AF run by a 3^{rd} party) sends API request verifying a user (user ID) to User-ID function.

The application server (which may be an AF run by a 3rd party) sends API request verifying a user (user ID) to User-ID function, after receiving the details from the user in Step 2a, Application server request the User-ID function to verify whether the User is active or not.

Step 4. User-ID function sends Nudm_UserAuth_Request including user ID to UDM.

The user-ID function asks whether and which UE is linked or associated with a particular User-ID.

The user-ID function may also request for receiving the serving AMF of the particular UE which is linked with the User-ID.

Step 5. UDM operation: ID conversion.

Based on the procedure in Step 1 which configured the UDM with UE and their associated User IDs, the entity (UDM here) checks the linked UEs (or the linked UE identifiers) to the User ID.

Step 6. UDM Send the message (Namf_Communication_UserAuthentication Request) to AMF to perform User authentication by providing UE identifier (SUPI/GPSI) and/or User Identifier.

Alternatively, Instead of AMF, UDM may also send this message to entity like AUSF/NSSAAF, and according will receive the response from the same entity in Step 10.

Alternatively, Instead of UDM, AMF may receive this message from some other entity like AUSF/NSSAF.

Step 7. AMFsends request (NAS-MM-User-Local-Auth Request) for performing User Local Authentication/User Authentication to UE.

AMF sends the UE (via NAS) the message to trigger User Local Authentication/User Authentication for the particular User ID received in Step 6.

Step 8. Based on the request received from the network (or the AMF), UE triggers authentication procedure for User Identity. The UE utilizes the stored configuration and information negotiated with the network in Step 1 (1a, 1b, 1c, 1d). The UE trigger the Authentication procedure for the particular User ID provided by the Network.

Based on the UE configuration for the User ID, UE may trigger an authentication procedure (e.g., EAP authentication) by providing credentials to the network,

According to an embodiment, the UE may perform a local authentication for the particular User ID and provide network with the result of local authentication in Step 9.

Step 9. UE provides the response (NAS-MM-User-Local-Auth Response) for User ID authentication to the network (AMF).

Step 10. AMF sends Namf_Communication_UserAuthentication Response to the UDM function. The Namf_Communication_UserAuthentication Response includes at least one of SUPI, User ID, or authentication result.

The AMF sends the UDM function the message corresponding to User ID authentication performed by UE and received in Step 9.

Step 11. UDM sends Nudm_UserAuth_Response to User ID Function. The Nudm_UserAuth_Response includes at least one of User ID, or authentication result.

The UDM updates its configuration based on the message received from AMF (e.g., updates the last authentication time/last active UE of the particular User, last active User of the UE, etc.).

The AMF sends the User ID function the message correspond to User ID authentication performed by UE and received in Step 10.

Step 12. User ID Function sends API response verifying a user (user ID, Result for the authentication) to Application server.

The user ID function receives the response in Step 11 and send the application server the result for the authentication for the User ID.

Referring to FIGS. 3A and 3B, operation by the AMF is described below.

According to an embodiment, Functionality described for AMF as below may also be realized by some other 5G control network entity e.g., NEF, NSSAAF, etc.

AMF in Step 6 may receive from UDM, the message Namf_Communication_UserAuthentication (new message type) Request, which includes one or more parameters of User ID, SUPI, GPSI, authentication-method.

Alternatively, AMF in Step 6, may receive a message with one or more parameters of “indication for performing User Authentication” User ID, SUPI, GPSI, authentication-method.

Alternatively, AMF in Step 6, may receive a message with one or more parameters of User ID, SUPI, GPSI, authentication-method.

Upon receiving message in Step 6, AMF tries to reach and find the UE associated with SUPI and/or User ID, and if AMF finds that UE is unreachable it proceeds to Step 10 and notify that UE can't be reached and/or authentication was unsuccessful, ELSE

AMF in Step 7, transmits towards UE the message, NAS-MM-User-Local-Auth Request (new message type), including one or more parameters of User ID. in order to trigger UE to start performing authentication for the provided User ID, authentication-method.

Alternatively, AMF in Step 7, may transmit a message with “indication for performing User authentication” and one or more parameters of User ID, authentication-method.

Alternatively, AMF in Step 7, may transmit a message with one or more parameters of User ID, authentication-method.

AMF in Step 9, may receive from UE (directly or via another NF), as the response of the Step 8, the message NAS-MM-User-Local-Auth Response, which one or more parameters of User ID, Authentication Related-Message.

Alternatively, AMF in Step 9, may receive a message having parameter “User authentication indication”, along with User ID, and Authentication Related-Message.

Alternatively AMF in Step 9, may receive the message including one or more parameters of User ID, Authentication Related-Message.

Upon receiving message in Step 9 from UE, or otherwise, AMF determines if the User-ID is authenticated or not, and as a response for the message received from UDM in Step 6,

AMF in Step 10, sends UDM the message Namf_Communication_UserAuthentication Response including one or more parameters of SUPI, GPSI User ID, Authentication Related-Message, indication whether UE is reachable or not.

Alternatively, AMF in Step 10, sends a message that include “indication of User Authentication result”, and one or more parameters of SUPI, GPSI User ID, Authentication Related-Message, indication whether UE is reachable or not.

Alternatively, AMF in Step 10, sends a message that include one or more parameters of SUPI, GPSI User ID, Authentication Related-Message, indication whether UE is reachable or not.

Referring to FIGS. 3A and 3B, operation by the USER-ID Function is described below.

According to an embodiment, some or all of USER-ID Function's functionality maybe realized via NEF or AF or NSSAAF or AUSF, and User ID functionality may be realized via GPSI or some Internal or External UE/User identifier.

User-ID Function in Step 3, may receive from a 5GS entity or a 3^{rd} party entity, a message to request authentication for a particular identifier (User ID/GPSI/External User ID), which includes one or more parameters of User ID.

Alternatively, User-ID Function in Step 3, may receive a message with “indication for performing User Authentication” and one or more parameters of User ID.

Upon receiving the message in Step 3 or based on some local configuration/triggers, User-ID function triggers the 5GS procedure, as depicted in Step 4 to Step 11, for performing User Authentication associated with a User Identifier that it received in Step 3, and

User-ID function in Step 4, transmits towards UDM (or some other control network entity like UDR) the message Nudm_UserAuth_Request (User ID), which includes one or more parameters of User-ID.

Alternatively, User-ID function in Step 4, may transmit a message, with “indication to perform Authorization for UserID”, and one or more parameters of User ID.

Alternatively, User-ID function in Step 4, may transmit a message, with one or more parameters of User ID.

User-ID function in Step 11, as a response to Step 4, may receive from UDM (or some other control network entity like UDR), the message Nudm_UserAuth (new message type) Response, including one or more parameters of SUPI, User ID, User Authentication Related-Message.

Alternatively, User-ID function in Step 11, may receive the message, including “indication of User Authentication result” and one or more parameters of SUPI, User ID, User Authentication Related-Message.

Alternatively, User-ID function in Step 11, may receive the message, including one or more parameters of SUPI, User ID, User Authentication Related-Message.

Upon receiving the message in Step 11 and/or as a response to the message received in Step 3, User-ID function determines if the User of the User-ID is authenticated by the system or not, and

User-ID function in Step 12, transmits towards a 5GS entity or a 3^{rd} party entity, a message which includes one or more parameters of User ID, User Authentication Result-Message.

Alternatively, User-ID Function in Step 12, may send a message with “indication of User Authentication result” and one or more parameters of User ID, User Authentication Result-Message.

Alternatively, User-ID Function in Step 12, may send a message, with one or more parameters of User ID, User Authentication Result-Message.

Referring to FIGS. 3A and 3B, operation by the UDM is described below.

UDM in Step 4, receives from User-ID function the message Nudm_UserAuth_Request(User ID), which includes one or more parameters of User-ID.

Alternatively, UDM in Step 4, may transmit a message, with “indication to perform Authorization for UserID”, and one or more parameters of User ID.

Alternatively, User-ID function in Step 4, may transmit a message, with one or more parameters of User ID.

UDM in Step 5, based on the message received in Step 4, converts the identifier received in Step 4 to an identifier used internally by 5G System to identify a particular User to identify a particular UE that is associated or linked to the identifier received in Step 4, This association between the identifier received in Step 4 and internal identifier identified by UDM in Step 5 may have been stored/configured in UDM during the operation of Step 1 (Steps 1a to Steps 1e) Between UE and UDM.

Identifier that the UDM identifies in the Step 5, which is used internally in the 5G System may be realized by SUPI, or GPSI, or Internal User Identifier.

UDM in Step 5 based on the stored or configured information further performs the following:
Check the UEs (that are associated with the User ID) which are active,
Decides whether the authentication is needed for the UE or not, based on if that User ID was recently authenticated by the Network for this UE. A timer maybe stored in the UDM for this purpose,
Checks if the UE subscription allows it to use User IDs,
Checks the registered PLMN for the UE and checks if UE is allowed to user the User-ID or User-ID functionality in the particular PLMN (e.g., allowed to use in roaming) based on the Subscription data.

UDM in Step 6, based on the operation performed by UDM in Step 5,
may transmit to AMF (or some other control network entity), the message Namf_Communication_UserAuthentication (new message type) Request, which includes one or more parameters of User ID, SUPI, GPSI, authentication-method.

Alternatively, UDM in Step 6, may transmit a message with one or more parameters of “indication for performing User Authentication” User ID, SUPI, GPSI, authentication-method.

Alternatively, UDM in Step 6, may transmit a message with one or more parameters of User ID, SUPI, GPSI, authentication-method.

UDM in Step 10, as a response to the message received in Step 11, receives from AMF (or some other control network entity), the message Namf_Communication_UserAuthentication Response including one or more parameters of SUPI, GPSI User ID, Authentication Related-Message.

Alternatively, UDM in Step 10, receives a message that include “indication of User Authentication result”, and one or more parameters of SUPI, GPSI User ID, Authentication Related-Message.

Alternatively, UDM in Step 10, receives a message that include one or more parameters of SUPI, GPSI User ID, Authentication Related-Message.

Upon receiving the message in Step 10, or otherwise,

UDM determines based on stored information (in Step 1, e.g., certificate or credential related information of the party which authorized the UE for authentication for the User ID or of the party responsible for performing local authentication for the User ID in the UE.) and received Authentication related-message in Step 10, whether the User is successfully authenticated or not, and

UDM in Step 11, as a response to Step 4, may send to User-ID Function, the message Nudm_UserAuth (new message type) Response, including one or more parameters of SUPI, User ID, User Authentication Related-Message.

Alternatively, UDM in Step 11, may send the message, including “indication of User Authentication result” and one or more parameters of SUPI, User ID, User Authentication Related-Message.

Alternatively, UDM in Step 11, may send the message, including one or more parameters of SUPI, User ID, User Authentication Related-Message.

### Local Authentication Performed by UE

The UE may be implemented in following two ways if the UE is configured to perform Local Authentication for a User Id.

In the below figured MODEM is a UE MODULE (or RF MODULE) responsible for the NAS signaling in the UE and is responsible for sending and receiving any messages to and from the network.

Upper layers are those parts of the UE through which a User may interact. They may include OS(operating system) and/or application layer.

The MODEM and upper layers may communicate via some System LSI interface.

FIG. 4 illustrates a UE implementation according to an embodiment of the disclosure.

Referring to FIG. 4, operation by the UE is described below.

In this option, the upper layers of UE (e.g., application layer or the OS layer) performs the checking of the user provided credentials with the credentials for the particular User-ID. These credentials may be stored/configured in the UE and associated to a particular User ID in Step 0 of FIG. 1˜, FIG. 2a, or FIG. 3a.

Referring to FIG. 4, in Step 6, upon receiving the NAS request (NAS-MM-User-Local-Auth-Request) from the network to trigger User-authentication for the User ID, (and optionally the authentication-method received), a MODEM (responsible for controlling NAS) checks the configured data regarding the authentication for the User ID. Based on this the MODEM sends in Step 7a, a trigger (Auth-trigger) to the upper layers (e.g., OS/Application layer) in the UE to perform authentication by providing auth-related-information (which includes an ID, authentication method, or any stored credentials (e.g., bio-metric information, password, pin, etc.) for the ID).

When the upper layers of the UE receives the message they check the stored configuration for the auth-related-information provided by the MODEM in Step 7a, and triggers authentication. In Step 7b, upper layers (e.g., OS/Application layer) may prompt the user to provide authentication credentials (e.g., biometrics, password, pin, etc.) and then checks whether the authentication credentials match the one associated with the ID for which authentication takes place. The upper layers might store the authentication credentials in their own relevant memory or may receive them from the MODEM.

After performing the authentication, Upper layer informs the MODEM regarding the result of the authentication in Step 7c.

MODEM upon receiving the message notifies to Network regarding the result of local authentication for the User ID, result being success/failure in Step 8.

FIG. 5 illustrates a UE implementation according to another embodiment of the disclosure.

Referring to FIG. 5, operation by the UE is described below.

In this option, the MODEM performs the checking of the user provided credentials with the credentials for the particular User-ID. These credentials may be stored/configured in the UE and associated to a particular User ID in Step 0 of FIG. 1, FIG. 2a, or FIG. 3a.

Referring to FIG. 5, in Step 6, upon receiving the NAS request (NAS-MM-User-Local-Auth-Request) from the network to trigger User-authentication for the User ID, (and optionally the authentication-method received), the MODEM (responsible for controlling NAS) checks the configured data regarding the authentication for the User ID. Based on this the MODEM sends in Step 7a, a trigger to the upper layers (e.g., OS/Application layer) in the UE to perform authentication by providing auth-related-information (which includes an ID, authentication method).

When the upper layers of the UE receives the message they check the stored configuration for the auth-related-information provided by the MODEM in Step 7a, and triggers authentication. In Step 7b, upper layers (e.g., OS/Application layer) may prompt the user to provide authentication credentials (e.g., biometrics, password, pin, etc.) in Step 7b. Upper layers then provide the authentication credentials received from the User to MODEM in Step 7c.

MODEM in Step 7d. checks the credentials received from upper later in Step 7c with the stored credentials for the User ID.

MODEM upon checking whether the credentials matches or not, notifies to Network in Step 8, regarding the result of local authentication for the User ID in Step 8.

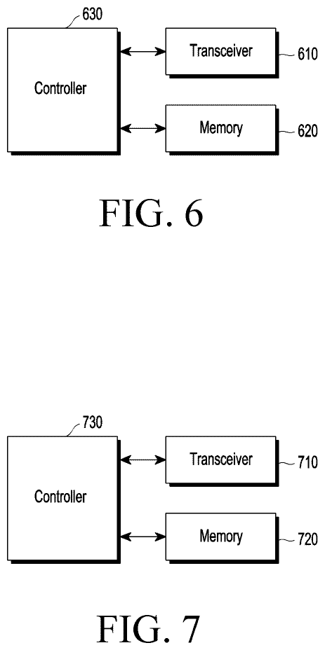

FIG. 6 illustrates a structure of a UE according to an embodiment of the disclosure.

The UE described with reference to FIGS. 1 to 5 may correspond to the UE of FIG. 6. Referring to FIG. 6, the UE may include a transceiver 610, a memory 620, and a controller 630.

The transceiver 610, controller 630, and memory 620 of the UE may be operated according to the above-described UE communication method. However, the components of the UE are not limited thereto. For example, the UE may include more or fewer components than the above-described components. The transceiver 610, the controller 630, and the memory 620 may be implemented in the form of a single chip. The controller 630 may include one or more processors.

The transceiver 610 collectively refers to a transmitter of the UE and a receiver of the UE and may transmit and receive signals to/from another device. To that end, the transceiver 610 may include a radio frequency (RF) transmitter for frequency-up converting and amplifying signals transmitted and an RF receiver for low-noise amplifying signals received and frequency-down converting the frequency of the received signals. However, this is merely an example of the transceiver 610, and the components of the transceiver 610 are not limited to the RF transmitter and the RF receiver.

The transceiver 610 may receive signals via a radio channel, output the signals to the controller 630, and transmit signals output from the controller 630 via a radio channel.

The memory 620 may store programs and data necessary for the operation of the UE. The memory 620 may store control information or data that is included in the signal obtained by the UE. The memory 620 may include a storage medium, such as read only memory (ROM), random access memory (RAM), hard disk, CD-ROM, and digital versatile disc (DVD), or a combination of storage media. Rather than being separately provided, the memory 620 may be embedded in the controller 630.

The controller 630 may control a series of processes for the UE to be able to operate according to the above-described embodiments.

FIG. 7 illustrates a structure of a network entity according to an embodiment of the disclosure.

The network entity described with reference to FIGS. 1 to 5 may correspond to the network entity of FIG. 7. The network entity of FIG. 7 is one of AMF (Access and Mobility Management Function), UDM (Unified Data Management), USER-ID Function, and 3^{rd} party APP. Referring to FIG. 7, the network entity may include a transceiver 710, a memory 720, and a controller 730.

The transceiver 710, controller 730, and memory 720 of the network entity may be operated according to the above-described network entity communication method. However, the components of the network entity are not limited thereto. For example, the network entity may include more or fewer components than the above-described components. The transceiver 710, the controller 730, and the memory 720 may be implemented in the form of a single chip. The controller 730 may include one or more processors.

The transceiver 710 collectively refers to a transmitter of the network entity and a receiver of the network entity and may transmit and receive signals to/from another device. To that end, the transceiver 710 may include a radio frequency (RF) transmitter for frequency-up converting and amplifying signals transmitted and an RF receiver for low-noise amplifying signals received and frequency-down converting the frequency of the received signals. However, this is merely an example of the transceiver 710, and the components of the transceiver 710 are not limited to the RF transmitter and the RF receiver.

The transceiver 710 may receive signals via a radio channel, output the signals to the controller 730, and transmit signals output from the controller 730 via a radio channel.

The memory 720 may store programs and data necessary for the operation of the network entity. The memory 720 may store control information or data that is included in the signal obtained by the network entity. The memory 720 may include a storage medium, such as read only memory (ROM), random access memory (RAM), hard disk, CD-ROM, and digital versatile disc (DVD), or a combination of storage media. Rather than being separately provided, the memory 720 may be embedded in the controller 730.

The controller 730 may control a series of processes for the network entity to be able to operate according to the above-described embodiments.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication system, the method comprising:
transmitting, to a UDM (unified data management), a first message for credentials for the UE, the credentials for the UE including at least one of name information, a mobile phone number, and a date of birth;
receiving, from the UDM, a second message indicating authentication success, wherein the second message includes a user ID corresponding to the credentials for the UE;
receiving, from an AMF (access and mobility management function), a third message to trigger local authentication of the UE; and
performing the local authentication for the UE based on the second message and the third message.

2. The method of claim 1, further comprising:
transmitting, to the AMF, a fourth message related to an authentication result as performed by the UE.

3. The method of claim 1, further comprising:
receiving, from a 3^{rd} party server, a request for authentication of the UE to verify an authenticity of specific user.

4. The method of claim 3, further comprising:
transmitting, to the 3^{rd} party server, a response including at least one of the user ID corresponding to the credentials for the UE, external UE IE, or name of authority which issued the user ID.

5. A method performed by at least one network entity in a wireless communication system, the method comprising:
receiving, from by a user equipment (UE), a first message for credentials for the UE, the credentials for the UE including at least one of name information, a mobile phone number, and a date of birth;
transmitting, to the UE, a second message indicating authentication success, wherein the second message includes a user ID corresponding to the credentials for the UE; and
transmitting, to the UE, a third message to trigger local authentication of the UE.

6. The method of claim 5, further comprising:
receiving, from the UE, a fourth message related to an authentication result as performed by the UE.

7. The method of claim 5, further comprising:
receiving, from a 3^{rd} party server, a request for verifying the user ID to identify an authenticity of specific user.

8. The method of claim 7, further comprising:
transmitting, to the 3^{rd} party server, a response including at least one of the user ID corresponding to the credentials for the UE, or result for authentication of the user ID.

9. A user equipment (UE) in a wireless communication system, the UE comprising:
a transceiver; and
a controller coupled with the transceiver and configured to control to:
transmit, to a UDM (unified data management), a first message for credentials for the UE, the credentials for the UE including at least one of name information, a mobile phone number, and a date of birth,
receive, from the UDM, a second message indicating authentication success, wherein the second message includes a user ID corresponding to the credentials for the UE,
receive, from an AMF (access and mobility management function), a third message to trigger local authentication of the UE, and
perform the local authentication for the UE based on the second message and the third message.

10. The UE of claim 9, wherein the controller is further configured to:
transmit, to the AMF, a fourth message related to an authentication result as performed by the UE.

11. The UE of claim 9, wherein the controller is further configured to:
receive, from a 3^{rd} party server, a request for authentication of the UE to verify an authenticity of specific user.

12. The UE of claim 11, wherein the controller is further configured to:
transmit, to the 3^{rd} party server, a response including at least one of the user ID corresponding to the credentials for the UE, external UE IE, or name of authority which issued the user ID.

13. At least one network entity in a wireless communication system, the network entity comprising:
a transceiver; and
a controller coupled with the transceiver and configured to control to:
receive, from by a user equipment (UE), a first message for credentials for the UE, the credentials for the UE including at least one of name information, a mobile phone number, and a date of birth, and
transmit, to the UE, a second message indicating authentication success, wherein the second message includes a user ID corresponding to the credentials for the UE, and
transmit, to the UE, a third message to trigger local authentication of the UE.

14. The network entity of claim 13, wherein the controller is further configured to:
receive, from the UE, a fourth message related to an authentication result as performed by the UE.

15. The network entity of claim 13, wherein the controller is further configured to:
receive, from a 3^{rd} party server, a request for verifying the user ID to identify an authenticity of specific user; and
transmit, to the 3^{rd} party server, a response including at least one of the user ID corresponding to the credentials for the UE, or result for authentication of the user ID.
